(19) United States
(12) Patent Application Publication
(10) Pub. No.: US 2003/0171941 A1
(43) Pub. Date: Sep. 11, 2003

(54) System and method for identifying synergistic opportunities within and between organizations

(76) Inventors: Carl Joseph Kraenzel, Boston, MA (US); Katherine A. Spanbauer, Woburn, MA (US); Mark A. Nowacki, Wilmington, MA (US)

Correspondence Address: MINTZ LEVIN COHN FERRIS GLOVSKY AND POPEO PC, 12010 SUNSET HILLS ROAD, SUITE 900, RESTON, VA, 20190, US

(21) Appl. No.: 10/091,573

(22) Filed: Mar. 7, 2002

(51) Int. Cl. G06F 17/60

(52) U.S. Cl. 705/1

(57) ABSTRACT

A system and method that helps people identify synergistic opportunities. In one aspect, a system according to the invention allows an entity, such as a person, a group of people, an organizational unit, or other entity, to declare the topics in which the entity is interested (e.g., the one or more projects that the entity is currently working on). The system is also operable to monitor the activities of a group of people to determine those people within the group that appear to be interested in a topic that has been declared. If the system determines that a person appears interested in a declared topic, the system is operable to automatically notify that person that the topic has been declared.

### BACKGROUND OF THE INVENTION

1. Field of the Invention

The present invention relates to a system and method for identifying synergistic opportunities within and between organizations.

2. Discussion of the Background

Large organizations, such as a corporation and other large organizations, commonly experience the problem of “the left hand not knowing what the right hand is doing.” This situation commonly arises in large organizations because it is difficult and costly to share information across different groups or business units within the organization. It is difficult and costly because large organizations generate a vast amount of information and may employ huge numbers of employees; thus, it is next to impossible to keep every employee fully informed about all the projects that the organization is working on or studying. As a result, people within the organization may miss out on identifying and exploiting synergistic opportunities. A synergistic opportunity is an opportunity for an entity to collaborate and/or share information with others with the goal of producing a synergistic effect.

For example, John, an employee that works for one business unit of an organization, may not necessarily know that Bob, an employee who works for a different business unit within the same organization, is working on the same problem that John is working on. If John could be notified that Bob is working on the same problem as John, then John can seek to collaborate with Bob and exploit the synergy between them. But if John is kept in the dark as to what Bob is working on, then it is likely that the synergistic opportunity will never be identified.

### SUMMARY OF THE INVENTION

The present invention provides a system, method, and computer program product that helps people identify synergistic opportunities. In one aspect, a system according to the invention allows an entity, such as a person, a group of people, an organizational unit, or other entity, to declare the topics in which the entity is interested (e.g., the one or more projects that the entity is currently working on). The system is also operable to monitor the computing activities of a group of people to determine those people that appear to be interested in a topic that has been declared. If the system determines that a person appears interested in a declared topic, the system is operable to automatically notify the person that the topic has been declared, and is also operable to provide the person with information concerning the topic and the entity that declared the topic so that the person can contact the entity to determine if there is a synergistic opportunity that can be exploited. For example, if the person and the entity are both trying to solve the same or similar problem, the person and the entity can discuss whether or not it makes sense to collaborate in solving the problem.

In one embodiment, an entity declares a topic in which it is interested by inputting information relating to the topic in a database. The information may include the name of the topic, a description of the topic, one or more keywords related to the topic, and other information.

In one embodiment, the computing activities monitored by the system may include electronic mail activity, instant messaging activity, web searching activity, and other activities that may shed light on the topics in which a person has an interest. In one embodiment, the system determines whether a person appears to be interested in a declared topic by determining whether the person's monitored activities match some or all of the information in the database that is related to the declared topic.

In one particular embodiment where an entity declares a topic by, among other things, inputting keywords related to the topic into the database, the system determines whether a person appears to be interested in the declared topic by determining whether N or more messages (e.g., e-mail messages, instant messages, and search request messages) sent from or to the person in a given period of time contain one or more of the keywords, where N is a number greater than zero.

In one aspect, the invention provides a computer program product that is embodied in a computer readable medium (e.g., floppy disk, compact disk, hard drive, etc.) and that includes computer instructions for: monitoring the computing activities of a user of a computer; determining if the computer user appears to be interested in a declared topic based on the monitored activities and based on information stored in a database that is associated with the declared topic; and notifying the computer user that the topic has been declared if it appears that the computer user is interested in the declared topic.

The above and other features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements. Additionally, the left-most digit(s) of a reference number identifies the drawing in which the reference number first appears.

FIG. 1 is a flow chart illustrating a process, according to an embodiment of the invention, for identifying potential synergetic opportunities.

FIG. 2 is a flow chart illustrating a process, according to one embodiment, that is performed when the monitored activities of a user indicate that the user may be interested in a declared topic.

FIG. 3 illustrates a system, according to one embodiment, that can be used to implement the processes of the present invention.

FIG. 4 illustrates an exemplary user interface that enables a user to enter information concerning a topic that the user desires to declare.

FIG. 5 shows a pop-up window that may be used to notify a user of the existence of a declared topic.

FIG. 6 illustrates an exemplary web page for, among other things, displaying to a user information associated with a declared topic.

### DETAILED DESCRIPTION OF THE PREFERRED EMBODIMENTS

While the present invention may be embodied in many different forms, there is described herein in detail an illustrative embodiment with the understanding that the present disclosure is to be considered as an example of the principles of the invention and is not intended to limit the invention to the illustrated embodiment.

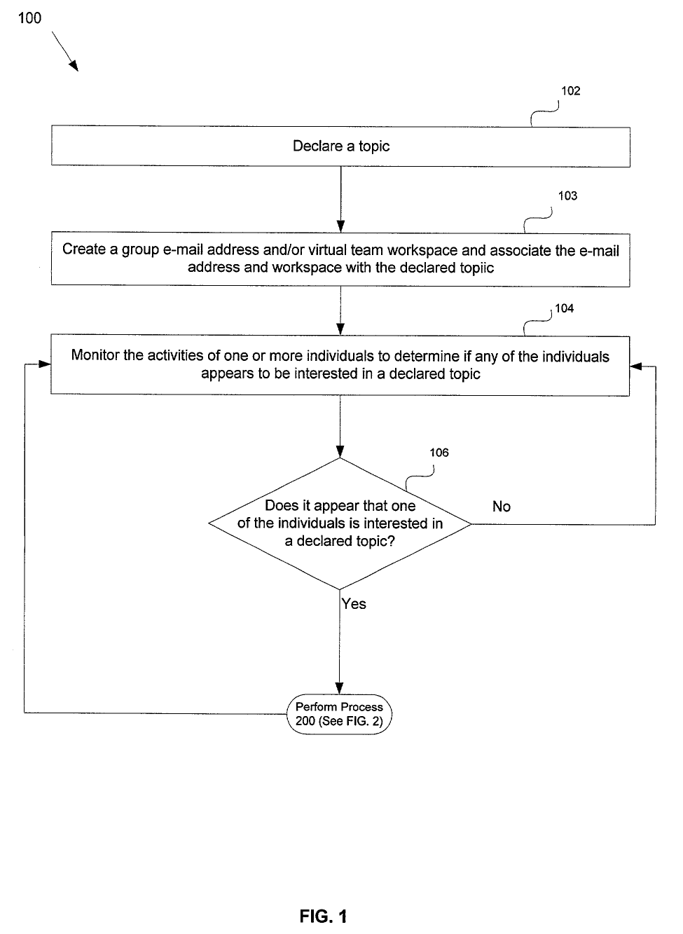

FIG. 1 is a flow chart illustrating a process 100, according to an embodiment of the invention, for identifying potential synergetic opportunities.

Process 100 begins in step 102 where an entity declares one or more topics that are of interest to the entity. By declaring a topic, the entity is in effect advertising that the entity is willing to collaborate and/or share information with others who share a common interest in the topic. In one embodiment, an entity declares a topic by inputting into a database information regarding the topic. The information inputted may include the name of the topic, a description of the topic, one or more keywords related to the topic, the reason(s) for declaring the topic, access limitations, an expiration date, the name of a group e-mail address, the name of a virtual team workspace, a link (e.g., a uniform resource locator (URL)) to an electronic bulletin board, one or more links to a web page, and/or other information.

The expiration date that is inputted by the entity specifies the expiration date of the declared topic. The expiration date for a declared topic is an important date because all declared topics are automatically de-activated on their expiration date. In one embodiment, a declared topic is de-activated by automatically removing from the database information associated with the declared topic. This information that is automatically removed from the database may optionally be automatically archived.

In step 103, in response to the entity declaring a topic, a group e-mail address and/or a virtual team workspace may automatically be created and associated with the topic.

In step 104, a group of computer users' computing activities are monitored. In one embodiment, for each of the one or more users in the group, the following activities are monitored: the user's e-mail, instant messaging, and/or web searching activity. Other activities may also be monitored.

A user's e-mail activity may be monitored by examining the contents of each e-mail message sent from and to the user. The user's e-mail activity can be monitored, for example, by examining the contents of each e-mail message sent from and to a computer associated with the user or by retrieving from an e-mail server each e-mail addressed to the user and/or sent by the user and examining the contents of those e-mail messages. Similarly, a user's instant messaging activity my be monitored by examining the contents of each instant message sent from and to the user, and a user's web searching activity may be monitored by examining each search request message that the user sends to a search engine, such as Yahoo!(g), Google™, or other search engine.

In step 106, a determination is made as to whether the monitored activities of a user indicate that the user may be interested in a declared topic. In one embodiment, the monitored activities of a user indicate that the user may be interested in a declared topic if N or more messages (e.g., e-mail messages, instant message, and search request messages) sent from or to the user in a given period of time contain a keyword that is associated with the declared topic, where N is a number greater than zero (0). Other methods may be used for determining whether the activities of a user indicate that the user may be interested in a declared topic.

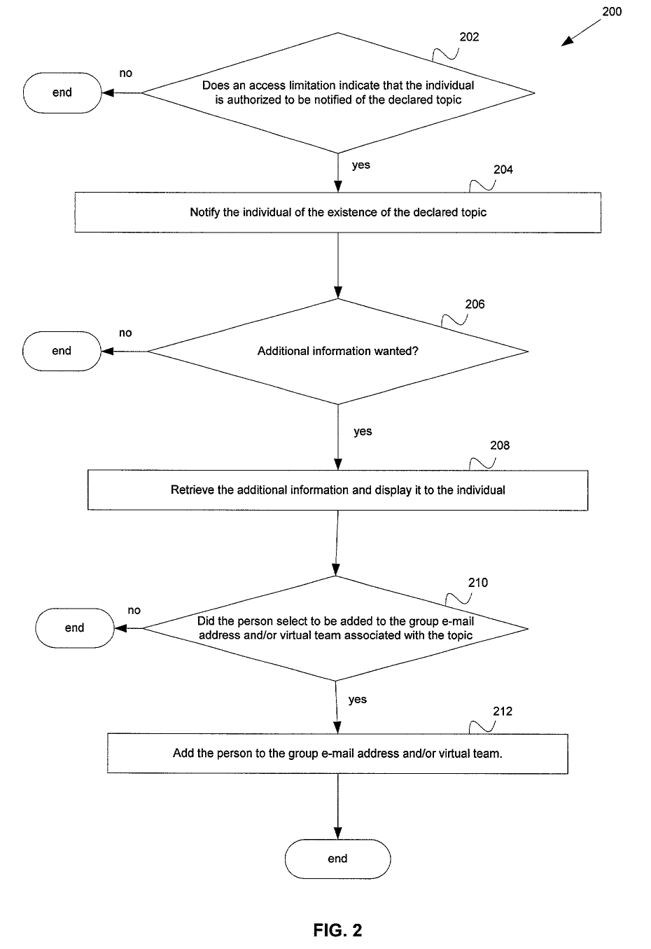

If the monitored activities of a user indicate that the user may be interested in a declared topic, then a process 200 is performed (see FIG. 2).

Process 200 begins in step 202, where a determination is made as to whether an access limitation associated with the declared topic in the database indicates that the user is authorized to be notified of the declared topic. If the user is authorized, then process 200 proceeds to step 204, otherwise process 200 ends.

In step 204, the user is automatically notified that his or her activities indicate that he or she may be interested in the declared topic. The automatic notification may be by means of an e-mail, an instant message, a foreground alert (e.g., a window that suddenly appears on the user's computer screen), or other notification means. The notification may include the name of the entity who declared the topic, the name of the topic, and a message that informs the user that he or she has the option of receiving additional information concerning the declared topic. Other information may also be included in the notification.

In step 206, a determination is made as to whether the user has chosen to receive the additional information. If the user chooses to receive the additional information, process 200 proceeds to step 208, otherwise process 200 ends. The user can choose to receive the additional information by clicking on a user interface button or link that is displayed to the user along with the notification. Other ways to enable the user to indicate his or her desire to receive the additional information are possible.

In step 208, the additional information, which is preferably stored in the database, is retrieved and displayed to the user on the user's computer screen. For example, in one embodiment, if it is determined that the user chose to receive the additional information, then a web browser on the user's computer is automatically launched (if it is not already running) and a web page that contains the additional information is automatically retrieved and displayed by the web browser.

The additional information may include, among other things, information that was inputted into the database by the entity who declared the topic. Thus, the information may include a brief description that explains why the topic was declared, a link pointing to a virtual team workspace, the name of a group e-mail address, a link to a web page, and other information.

Additionally, if a group e-mail address and/or a virtual team is associated with the declared topic, then the additional information may inform the user that, if the user so chooses, he or she can be added to the group e-mail address so that he or she will receive e-mails sent to that address and/or added to the virtual team so that he or she can access a virtual team workspace that enables the virtual team to collaborate and share information easily. The user can choose to become a member of the group e-mail address and/or virtual team by sending an e-mail to a specified address or by clicking on a user interface button or link that is displayed to the user along with the additional information. Other ways to enable the user to choose to become a member are possible.

In step 210, a determination is made as to whether the user has chosen to become a member of the group e-mail address and/or virtual team. If the user has so chosen, then the user is automatically added to the group e-mail address and/or the virtual team, and a message may be automatically generated and transmitted to the entity who declared the topic, wherein the message informs the entity of the name of the user who has just been added to the group e-mail and/or virtual team.

As can be seen from the above description, processes 100 and 200 together provide a method for identifying and exploiting synergistic opportunities by allowing an entity to declare a topic, monitoring the activities of a group of people to determine those that appear to be interested in the topic, notifying automatically those people that they appear to be interested in the topic, and giving those people the option of becoming a member of a team of people who are also interested in the topic.

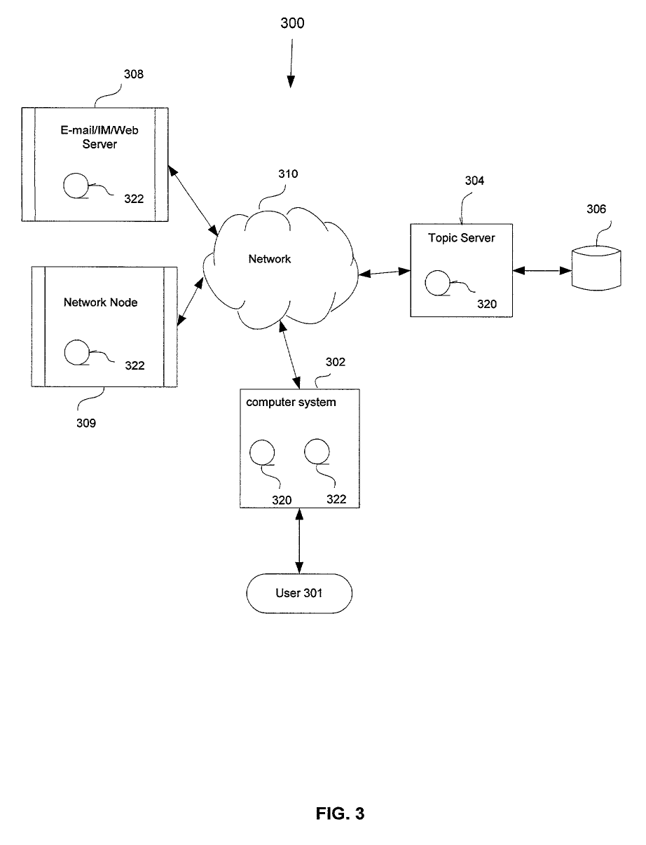

FIG. 3 illustrates a system 300, according to one embodiment, that can be used to implement the above processes 100 and 200. Other systems can be used to implement the above process 100 and 200. Nevertheless, for the sake of illustration, system 300 is described in detail below.

System 300 includes a computer system 302, a topic server 304, and a database 306. Computer system 302 is able to communicate with server 304 through a network 310. System 300 further includes a first software tool 320 and a second software tool 322 (also referred to as “monitor 322”).

Software tool 320 enables a user to declare topics. That is, software tool 320 enables a user to input into database 306 information concerning a topic. Software tool 302 can execute on computer system 302 or server 304, as illustrated in FIG. 3.

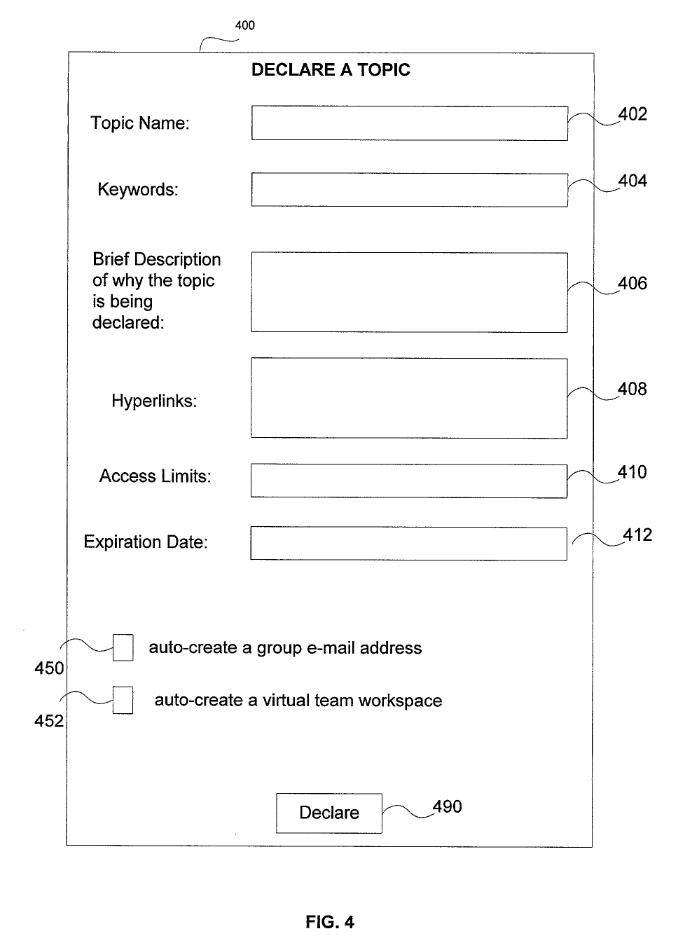

FIG. 4 illustrates an exemplary user interface 400 produced by software tool 320. User interface 400 enables a user to enter information concerning a topic that the user desires to declare. More specifically, user interface 400 includes a text box 402 for receiving from the user the name of the topic to be declared, a text box 404 for receiving from the user one or more keywords that the user wishes to associate with the declared topic, a text box 406 for receiving from the user a brief description of why the user is declaring the topic, a text box 408 for receiving from the user one or more links to web pages that may have useful information concerning the topic, a text box 410 for receiving from the user access limitation information, and a text box 412 for receiving from the user an expiration date.

User interface 400 also includes two check boxes 450 and 452. The user will select those check boxes if the user wants software tool 320 to automatically create a group e-mail address and virtual team workspace, respectively.

After the user has entered text into one or more of text boxes 402-412 and selected the check boxes 450 and 452 as desired, the user declares the topic by clicking declare button 490. In response to the user clicking declare button 490, software tool 320 stores the information inputted by the user into one or more records in database 306.

As described above, the expiration date entered by the user specifies the date on which the topic is de-activated (i.e., undeclared). Software tool 320 may un-declare a topic by setting a particular flag associated with the topic and/or removing from database 306 information associated with the topic. If the user does not specify an expiration date, a default expiration date may be used. For example, the default expiration date may be one month from the date the topic was declared.

Referring now to monitor 322, monitor 322 functions to determine if one or more users (e.g., user 301 who is using the computer system 302) appears to be interested in a declared topic. Monitor 322 determines whether user 301 appears interested in a declared topic by monitoring user 301's computing activities. In one embodiment, the computing activities monitored by monitor 322 include electronic mail activity, instant messaging activity, and web searching activity. Monitor 322 determines whether user 301 appears to be interested in a declared topic by determining whether the user's monitored activities match some or all of the information in database 306 that is related to the declared topic. In one particular embodiment where an user declares a topic by, among other things, inputting one or more keywords related to the topic into database 306, monitor 322 determines whether user 301 appears to be interested in the declared topic by determining whether N or more messages (e.g., email messages, instant messages, and search request messages) sent from or to user 301 in a given period of time contain one or more of the keywords, where N is a number greater than zero and the given period of time can be configured by an administrator.

As show in FIG. 3, a monitor may be installed on computer system 302, on network node 309, which is operable to receive all network data traffic sent to and from the computer system 302, and/or on an e-mail, instant message, and/or web server 308. When a monitor 322 is installed in computer system 302, monitor 322 is able to examine the data that is inputted (e.g., by means of a keyboard or other input device) into the computer system 302 by user 301 as well as data that is contained in messages that are transmitted to and from computer system 302, such as e-mail messages, instant messages, web search request messages, and other messages. When a monitor 322 is installed on network node 309, monitor 322 is able to examine the data that is contained messages that are transmitted to and from the computer system 302, but may not be able to examine the data that is inputted by a user into a computer system 302. When a monitor is installed on server 308, monitor is able to examine the messages sent to server 308 by user 301 and/or the messages sent to user 301 by server 308. For example, if server 308 is an e-mail server and user 301 has an e-mail account that is served by the e-mail server, then monitor 322 may be given access to the e-mail server and given permission to examine each e-mail sent to/from user 301. This is useful if user 301 has the ability to send and receive e-mail from multiple devices because it allows user 301 's e-mail activity to be monitored without having to install a monitor 322 on each of the devices.

When the monitor 322 determines that user 301 appears to be interested in a declared topic, the monitor 322 retrieves from database 306 the access limitation information, if any, that is associated with the declared topic. Next, the monitor 322 determines whether the access limitation information prohibits user 301 from being notified of the declared topic. If the access limitation information prohibits user 301 from being notified, then monitor 322 does not notify user 301, otherwise monitor 322 notifies user 301 that his or her activities indicate that he or she may be interested in the declared topic. As described above, there are several ways in which user 301 can be so notified.

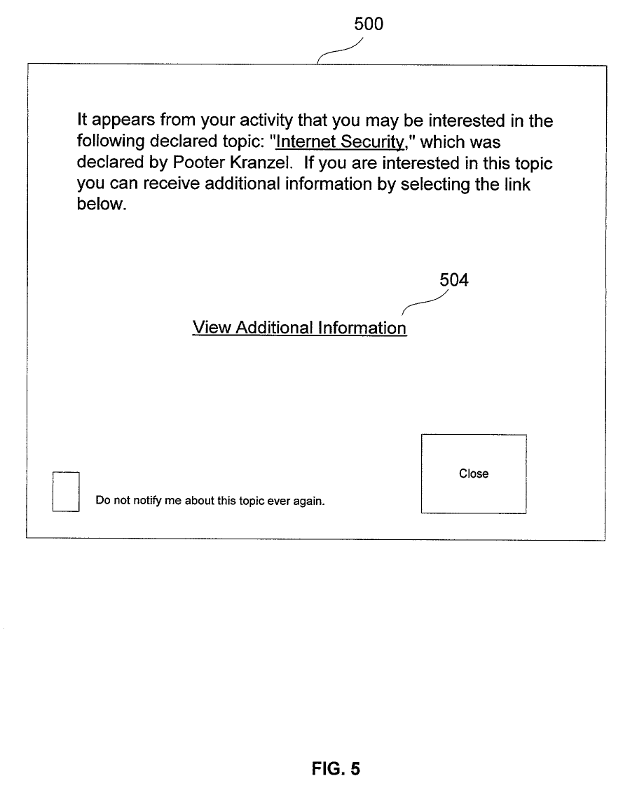

For illustrative purposes, FIG. 5 shows a pop-up window 500 that may be used by monitor 322 to so notify user 301. As shown in FIG. 5, pop-up window 500 includes text that informs user 301 that his or her activity indicates that user 301 may be interested in a declared topic. Additionally, pop-up window 500 includes a hyperlink 504 to additional information concerning the declared topic. Hyperlink 504 informs user 301 that user 301 has the option of receiving the additional information. If user 301 so chooses, user 301 may select (e.g., “click on”) hyperlink 504.

In one embodiment, hyperlink 504 is configured such when user 301 selects hyperlink 504 a web browser on user 301 's computer is automatically launched and sends a request to server 304 for detailed information concerning the topic in question. In response to receiving the request, server 304 generates a web page that includes the requested information and transmits the web page to the web browser, which then displays the web page to user 301.

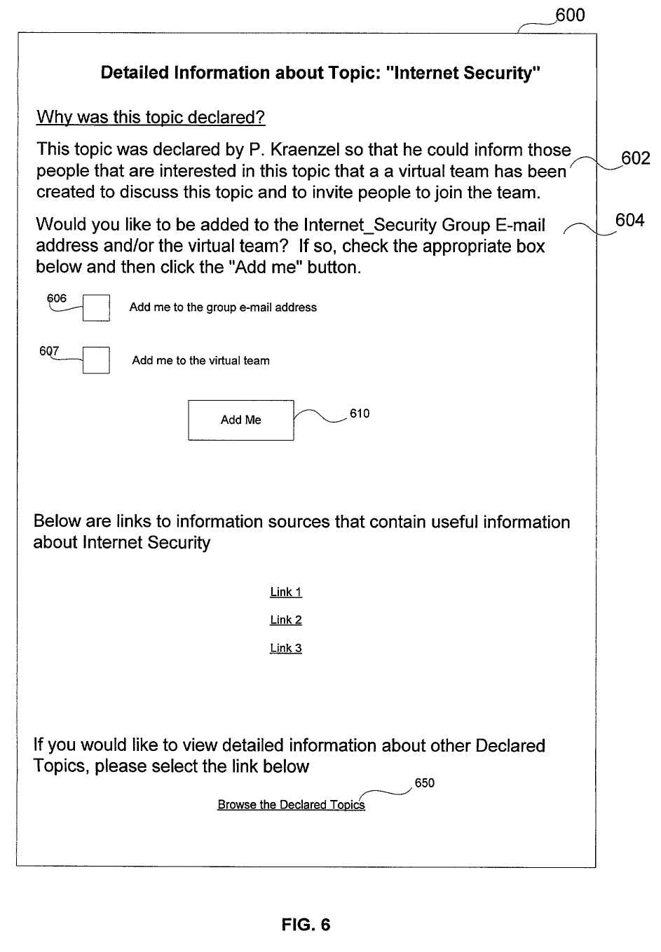

FIG. 6 illustrates an exemplary web page 600 that is transmitted by server 304 in response to receiving a request for detailed information concerning a topic that has been declared in database 306. Web page 600 includes information that was inputted by the entity that declared the topic. For example, web page 600 includes text 602 that briefly explains why the entity declared the topic. Web page 600 may also include text 604 that informs user 301 that he or she has the option of joining a group e-mail address and/or virtual team, checkboxes 606 and 607 for enabling user 301 to indicate that he or she wants to be added to the group e-mail address and/or virtual team, respectively, and a button 610. User 301 activates button 610 after selecting one or more of checkboxes 606 and 607. In response to user 301 activating button 610, the web browser sends to server 304 a request that indicates the selection made by user 301. Upon receiving the request, server 304 takes the necessary steps to add user 301 to the group e-mail address and/or virtual team as selected by user 301.

As an additional feature, user 301 is allowed to browse all or some of the topics that have been declared in database 306. For example, web page 600 may include a hyperlink 650 that when selected by user 301 causes a web page to be loaded that lists all or some of the topics declared in database 306, and by selecting one of the topics in the list, information associated with the selected topic in database 306 is retrieved from database 306 and displayed to user 301.

While various illustrative embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What Is claimed Is:

1. A computer implemented method, comprising the steps of:
monitoring the computing activities of a user of a computer;
determining if the computer user appears to be interested in a declared topic based on the monitored activities and based on information stored in a database that is associated with the declared topic; and
notifying the computer user that the topic has been declared if it appears that the computer user is interested in the declared topic.

2. The method of claim 1, wherein the step of monitoring the activities of the user comprises the step of monitoring one or more e-mail messages sent to and/or from the user.

3. The method of claim 2, wherein the step of monitoring one or more email messages sent to and/or from the user comprises the step of examining one or more e-mail messages transmitted to and/or from the computer.

4. The method of claim 2, wherein the step of monitoring one or more email messages sent to and/or from the user comprises the step of retrieving from an email server one or more e-mail messages addressed to the user and/or sent by the user and examining the contents of those e-mail messages.

5. The method of claim 1, wherein the step of monitoring the activities of the user comprises the step of examining one or more instant messages sent to and/or from the user.

6. The method of claim 1, wherein the step of monitoring the activities of the user comprises the step of monitoring one or more search request messages sent from the user.

7. The method of claim 6, wherein the step of monitoring one or more search request messages sent from the user comprises the step of examining one or more search request messages transmitted from the computer.

8. The method of claim 1, further comprising the steps of:
determining whether the computer user desires to receive information about the declared topic after notifying the computer user that the topic has been declared; and
retrieving from the database information about the declared topic, wherein the information was inputted into the database by an entity that declared the topic.

9. The method of claim 1, wherein the information stored in a database that is associated with the declared topic comprises one or more keywords.

10. The method of claim 9, wherein the step of monitoring the computing activities of a user of a computer comprises the step of examining one or more messages sent from and/or to the user.

11. The method of claim 10, wherein the step of determining if the computer user appears to be interested in the declared topic comprises the step of determining whether N or more of the examined messages includes one of the one or more keywords, where N is a number greater than zero.

12. The method of claim 1, further comprising the steps of:
determining whether the user selected to be added to a group e-mail address and/or virtual team associated with the topic;
adding the user to the group e-mail address if it is determined that the user selected to be added to the group e-mail address; and
adding the user to the virtual team if it is determined that the user selected to be added to the virtual team.

13. A computer signal embodied in a carrier wave readable by a computing system and encoding a computer program of instructions for executing a computer process performing the method recited in claim 1.

14. A system, comprising:
monitoring means for monitoring the computing activities of a user of a computer;
determining means for determining if the computer user appears to be interested in a declared topic based on the monitored activities and based on information stored in a database that is associated with the declared topic; and
notifying means for notifying the computer user that the topic has been declared if it appears that the computer user is interested in the declared topic.

15. The system of claim 14, wherein the monitoring means comprises means for monitoring one or more e-mail messages sent to and/or from the user.

16. The system of claim 15, wherein the means for monitoring one or more e-mail messages sent to and/or from the user comprises means for examining one or more e-mail messages transmitted to and/or from the computer.

17. The system of claim 15, wherein the means for monitoring one or more e-mail messages sent to and/or from the user comprises means for retrieving from an email server one or more e-mail messages addressed to the user and/or sent by the user and for examining the contents of those e-mail messages.

18. The system of claim 14, wherein the monitoring means comprises means for examining one or more instant messages sent to and/or from the user.

19. The system of claim 14, wherein the monitoring means comprises means for monitoring one or more search request messages sent from the user.

20. The system of claim 19, wherein the means for monitoring one or more search request messages sent from the user comprises means for examining one or more search request messages transmitted from the computer.

21. The system of claim 14, further comprising:
determining means for determining whether the computer user desires to receive information about the declared topic after notifying the computer user that the topic has been declared; and
retrieving means for retrieving from the database information about the declared topic, wherein the information was inputted into the database by an entity that declared the topic.

22. The system of claim 14, wherein the information stored in a database that is associated with the declared topic comprises one or more keywords.

23. The system of claim 22, wherein monitoring means comprises means for examining one or more messages sent from and/or to the user.

24. The system of claim 23, wherein means for determining if the computer user appears to be interested in the declared topic comprises means for determining whether N or more of the examined messages includes one of the one or more keywords, where N is a number greater than zero.

25. The system of claim 14, further comprising the steps of:
determining means for determining whether the user selected to be added to a group e-mail address and/or virtual team associated with the topic;
means for adding the user to the group e-mail address if it is determined that the user selected to be added to the group e-mail address; and
means for adding the user to the virtual team if it is determined that the user selected to be added to the virtual team.

26. A computer program product, the computer program product being embodied in a computer readable medium and comprising computer instructions for:
monitoring the computing activities of a user of a computer;
determining if the computer user appears to be interested in a declared topic based on the monitored activities and based on information stored in a database that is associated with the declared topic; and
notifying the computer user that the topic has been declared if it appears that the computer user is interested in the declared topic.

27. The computer program product of claim 26, wherein the instructions for monitoring the activities of the user comprises instructions for monitoring one or more e-mail messages sent to and/or from the user.

28. The computer program product of claim 27, wherein instructions for monitoring one or more e-mail messages sent to and/or from the user comprises instructions for examining one or more e-mail messages transmitted to and/or from the computer.

29. The computer program product of claim 27, wherein instructions for monitoring one or more e-mail messages sent to and/or from the user comprises instructions for retrieving from an e-mail server one or more e-mail messages addressed to the user and/or sent by the user and examining the contents of those e-mail messages.

30. The computer program product of claim 26, wherein instructions for monitoring the activities of the user comprises instructions for examining one or more instant messages sent to and/or from the user.

31. The computer program product of claim 26, wherein instructions for monitoring the activities of the user comprises instructions for monitoring one or more search request messages sent from the user.

32. The computer program product of claim 31, wherein instructions for monitoring one or more search request messages sent from the user comprises instructions for examining one or more search request messages transmitted from the computer.

33. The computer program product of claim 26, further comprising instructions for:
determining whether the computer user desires to receive information about the declared topic after notifying the computer user that the topic has been declared; and
retrieving from the database information about the declared topic, wherein the information was inputted into the database by an entity that declared the topic.

34. The computer program product of claim 26, wherein the information stored in a database that is associated with the declared topic comprises one or more keywords.

35. The computer program product of claim 34, wherein instructions for monitoring the computing activities of a user of a computer comprises instructions for examining one or more messages sent from and/or to the user.

36. The computer program product of claim 35, wherein instructions for determining if the computer user appears to be interested in the declared topic comprises the step of determining whether N or more of the examined messages includes one of the one or more keywords, where N is a number greater than zero.

37. The computer program product of claim 26, further comprising instructions for:
determining whether the user selected to be added to a group e-mail address and/or virtual team associated with the topic;
adding the user to the group e-mail address if it is determined that the user selected to be added to the group e-mail address; and
adding the user to the virtual team if it is determined that the user selected to be added to the virtual team.
